(19) United States
(12) Patent Application Publication
(10) Pub. No.: US 2008/0295863 A1
(43) Pub. Date: Dec. 4, 2008

(54) METHOD AND DEVICE FOR PROCESSING OR TREATING SILICON MATERIAL

(75) Inventor: Heinz KAPPLER, Dornstetten-Aach (DE)

Correspondence Address: AKERMAN SENTERFITT, P.O. BOX 3188, WEST PALM BEACH, FL, 33402-3188, US

(73) Assignee: Gebr. Schmid GmbH & Co., Freudenstadt (DE)

(21) Appl. No.: 12/177,741

(22) Filed: Jul. 22, 2008

Related U.S. Application Data
(63) Continuation of application No. PCT/EP2007/000523, filed on Jan. 23, 2007.

(30) Foreign Application Priority Data
Jan. 23, 2006 (DE) 10 2006 003 990.4

(51) Int. Cl. B08B 3/08; B08B 1/02

(52) U.S. Cl. 134/3; 134/32; 134/26; 134/18; 134/30; 134/126; 134/104.2; 134/95.1

(57) ABSTRACT

A method for processing or treating silicon material in carrying out a cleaning or purification process comprises the following steps: wetting bulk silicon material, facing a first direction with a first liquid process medium, automatic changing of an orientation of the bulk silicon material by turning bulk silicon material with a turning device and wetting the bulk silicon material in the altered orientation with the first liquid medium. After that, the bulk silicon material is cleaned in a corresponding cleaning device.

### FIELD OF APPLICATION AND PRIOR ART

The invention relates to a method and a device for processing or treating silicon material.

The prior art discloses such a processing method and such a device suitable for performing the method which are used for cleaning silicon raw material. The silicon raw material, which can in particular be in the form of silicon fragments or lumps of varying sizes, is prepared by the processing method so as to be suitable for further processing, for example in order to produce therefrom silicon wafers for semiconductor manufacture or silicon plates for solar cell manufacture. For processing purposes the silicon material is conveyed into a process chamber and is treated there with one or more liquid and/or gaseous process media or process medium combinations, in order to eliminate surface contaminants such as for example metal residues and/or oxide films. It is not possible to ensure when using a liquid process medium that all surface areas of the silicon material are wetted with the process medium. In addition, residues of the liquid process medium or the contaminants detached by said process medium can remain on the silicon material surface despite a subsequent rinsing process.

### PROBLEM AND SOLUTION

The problem of the invention is to provide an aforementioned device and an aforementioned method which are able to avoid the problems of the prior art and which in particular can bring about an improved silicon material cleaning action.

This problem is solved by a method having the features of claim 1 and a device having the features of claim 12. Advantageous and preferred developments of the invention form the subject matter of the further claims and are explained in greater detail hereinafter. The method and device are in part jointly described and these descriptions and the corresponding features apply independently for the method and the device. By express reference the wording of the claims is made into part of the content of the description.

According to a first aspect of the invention a method for the processing or treatment of silicon material with a cleaning process is provided, the cleaning process having the steps of wetting the silicon material, which is oriented in a first spatial orientation, with a first, liquid process medium, automated modification of the orientation of the silicon material by means of a turning or reversing device, wetting the silicon material in the modified orientation with the first, liquid process medium. The silicon material, which can in particular be in the form of irregular fragments with a typical edge length of less than 10 cm and a typical volume of less than 1000 cm³, for example in roughly first-size and smaller lumps or pieces, is firstly wetted in a first spatial orientation with a first liquid process medium. The spatial orientation of the silicon material is obtained in arbitrary manner by conveying the lumps into the process chamber in which the cleaning process is performed. The lumps for example rest with a contact surface or with several contact points on a substrate and are wetted in said spatial orientation with the liquid process medium, particularly by spraying. Despite the spraying of the silicon material, which preferably takes place from several spatial directions with several spray nozzles, which can in particular apply spray jets or spray mist to the silicon material, as a result of the contour of the individual lumps it is not ensured that all the surface portions of the typically irregularly shaped fragments of the silicon material are wetted with the liquid process medium.

To be able to achieve an advantageous cleaning action, following the first wetting with the process medium, the silicon material orientation is advantageously modified in automated manner by means of a turning device, so that the silicon material now rests on another contact surface or other contact points with respect to the substrate and consequently assumes a modified spatial orientation, and for example is positioned differently. Thus, when the liquid process medium is applied again wetting also takes place to surface portions which could not be wetted-prior to the position change. In a preferred embodiment of the invention the turning device is constructed in such a way that at least 50% of the silicon material undergoes a position change of at least 20° during the turning process. In a particularly preferred embodiment of the invention at least 75% of the silicon material undergoes a position change of at least 20° during the turning process.

According to a development of the invention in the cleaning process there are at least two orientation changes between at least three wetting processes. With at least three cleaning processes, for example with a time sequence of three wetting processes for the silicon material and the orientation changes in each case provided between the individual cleaning processes, with high reliability an almost complete wetting of all the outer surfaces of the silicon material with said process medium can be brought about. In each case the turning device brings about an orientation change between the cleaning processes and may expose not yet wetted surface portions to a following wetting with process medium. Thus, a number of n cleaning processes is to be compared with n-1 orientation changes.

According to a further development of the invention a silicon material wetting with process medium also takes place at least during one of the orientation changes. During the orientation modification, which is the same as a relative movement of the individual lumps of silicon material relative to the substrate, surface portions of the silicon material can undergo wetting with the process medium which may not have been wetted with process medium either in the first or in a further spatial orientation. This can bring about a particularly advantageous cleaning effect with a small number of orientation changes, particularly a single orientation change.

According to a further development of the invention, a first cleaning process is followed by at least one or more and in particular similarly effected cleaning processes with different process media, where there is at least one first silicon material wetting with process medium, at least one silicon material orientation change and at least one further silicon material wetting with process medium. As a result of a series arrangement or linkage of several cleaning processes, which in particular in each case implement at least two wetting processes and at least one intermediately provided orientation modification, it is possible to bring about a removal of different contaminants from the outer surface of the silicon material, preferably using different process media.

In a further development of the invention the process medium is constituted by at least one substance from the group: hydrofluoric acid (HF), hydrochloric acid (HCl), nitric acid (HNO₃) and potassium hydroxide solution (KOH), particularly in aqueous solution. These process media make it possible to remove oxide films metal ions and other contaminants from the outer surface of the silicon material. The substances are in particular used in an aqueous solution in order to be able to bring about a clearly defined, not excessively aggressive cleaning action. The substances can also be intermixed and brought into aqueous solution so as to achieve a combined cleaning effect.

According to a further development of the invention use is made for a first cleaning process of water-dissolved hydrofluoric acid (HF_{(aq)}) or water-dissolved nitric acid (HNO_{3(aq)}) as the process medium, for a second cleaning process water-dissolved potassium hydroxide solution (KOH_{(aq)}) as the process medium and for a third cleaning process water-dissolved hydrochloric acid (HCL_{(aq)}) as the process medium. With this sequence of process media in succeeding cleaning processes it is possible to ensure a particularly reliable removal of the relevant contaminants on the silicon material outer surfaces.

According to a further development of the invention at least one and in particular each cleaning process is followed by a rinsing process, particularly using deionized water and a rinsing device. In a rinsing process, which can be implemented with or without a silicon material orientation change, the contaminants removed by the process medium from the outer surface and also the actual process medium can be removed and consequently do not impede the further silicon material cleaning in a following cleaning process. It is also possible to ensure that process medium residues of an upstream cleaning step do not react in an undesired manner in a downstream cleaning step with the process medium used there. The rinsing process can take place in the same process chamber as the cleaning process, but it is also possible for the rinsing process for the silicon material to be transported into a separate rinsing chamber with dosing openings for the rinsing medium. In a preferred embodiment of the invention there is an annular arrangement of spray nozzles permitting an almost all-sided application of rinsing medium to the silicon material.

According to a further development of the invention the cleaning process or processes are performed with a substantially continuous, particularly automated conveying of silicon material, with a substantially continuous wetting of the silicon material with process medium and with at least one orientation change for the silicon material, particularly in a cleaning chamber. A continuous conveying permits the effective cleaning in a brief time interval of a large amount of silicon material. Continuous silicon material conveying means that the silicon material is moved in at least one space direction by a conveyor and at least one first wetting device, a turning device and a second wetting device are traversed. Whereas the wetting devices are constructed for a substantially continuous delivery of process medium to the silicon material outer surface, the turning device is constructed for a substantially continuous silicon material orientation change. Through the combination of a continuous conveying of silicon material with continuous wetting and the continuous orientation change a single silicon material lump on traversing the first wetting device undergoes a first wetting with process medium. This is followed by a turning or reversing process with an orientation change and then on traversing the second wetting device a further process medium application takes place. This permits a continuous cleaning process, which still ensures a reliable cleaning of at least virtually all the surface portions of the silicon material.

In a further development of the invention for a change to the spatial orientation the silicon material is conveyed by a first conveyor onto a second conveyor spaced from the former and which is located below said first conveyor, so that the silicon material drops from the first conveyor onto the second conveyor, accompanied by a modification of the spatial orientation. Through the spacing of the conveyors, between the said conveyors the silicon material covers a path section in which it at least briefly is not in contact with a substrate, for example with one of the conveyors. Trough the removal of the silicon material from the first conveyor and the arrival or application to the second conveyor the desired orientation change is brought about. Preferably the conveyors are vertically spaced, for example superimposed, so that the silicon material drops from the first conveyor onto the second conveyor and thereby changes its spatial orientation or position. The orientation change can also be assisted by different speeds of the successively arranged conveyors, particularly by a higher speed of the in each case downstream conveyor.

In a further development of the invention following at least one cleaning process and/or following at least one rinsing process, there is a silicon material drying process. This ensures that moisture residues of the process medium or rinsing medium do not. lead once again to contaminants adhering to the silicon material outer surfaces. Moreover, particularly in the case of process medium residues, a progression of the reaction of the particular process medium with the outer surface of the silicon material can be reduced or stopped. The drying process is preferably in the form of hot air drying or infrared drying, where the silicon material is continuously conveyed through a drying chamber in which the drying process takes place.

According to another aspect of the invention a device is provided for the processing of silicon material and in particular for performing the aforementioned method, which has at least one conveyor for conveying silicon material in at least one conveying direction, with at least one turning device associated with the conveyor for modifying a spatial orientation of the silicon material and with in each case at least one wetting device for wetting the silicon material with a process medium located upstream of the turning device in the conveying direction and downstream of the turning device in the conveying direction. The in particular automatic conveyor permits a continuous conveying of the silicon material in the at least one conveying direction. Silicon material conveying can in particular take place along a linear or curved space line. Automated conveying can in particular be implemented by an extraneous force-operated conveyor, for example with an electromotive drive. The turning device can be constructed in active or passive manner. With an active turning device by means of a cyclic or acyclic exerting of a force an orientation change for the silicon material can be brought about, for example by a gripping arm, which grips the silicon material and actively changes the spatial orientation. With a passive turning device use is made for an orientation change of the kinetic energy and/or potential energy of the silicon material which is in any case present as a result of the conveying action, so that a turning device with a simple construction can be obtained.

According to a further development of the invention the conveyor has a circulating, continuous conveyor belt with a top side or strand and a bottom side or strand, the top side being oriented at an acute angle to the horizontal and is used for silicon material conveying. The top and bottom strands are formed by a continuous, annular, circulating, flexible material belt. The top side of the conveyor belt is the surface area directed upwards away from the conveyor and movable in the conveying direction, whose surface normal is substantially vertically upwardly directed. This surface area, without further aids, serves as the substrate for the silicon material. The surface normal can in particular assume an acute angle with the vertical, for example during conveying the silicon material overcomes a height difference. By means of the continuous conveyor belt and a drive mechanism for example constructed as an electric motor, a large silicon material quantity can be conveyed in a short time.

According to a further development of the invention the conveyor belt comprises a process-medium-permeable material, particularly a mesh material. This ensures that following application to the outer surface of the silicon material the process medium can drip, without collecting between the underside of the silicon material and the substrate in the form of a closed surface. This in particular ensures that the contaminants removed from the process medium do not collection the underside of the silicon material. In a preferred embodiment of the invention by means of a process medium wetting device located below the top side there can also be a wetting of the underside of the silicon material by means of substantially vertically upwardly directed spray jets. As a result of the permeable design of the conveyor belt, it is consequently possible both to bring about a concentration of contaminants on the underside of the silicon material and also an advantageous wetting of the underside of said silicon material.

In a further development of the invention the turning device is constructed as at least one guide rail for a silicon material orientation change positioned at an acute angle to the conveying direction and oriented orthogonally and adjacent to a surface of the top side. This constitutes a passive turning device, which in the manner of a baffle or deflector plate exerts on the silicon material a force directed substantially perpendicular to the conveying direction and which can therefore bring about an orientation change. To this end the guide rail is positioned adjacent to the surface of the top side, so that it can engage with virtually all the silicon material lumps resting on the top side. The guide rail has a deflecting surface assuming an acute angle to the conveying direction and whose surface normal is substantially horizontally oriented. Silicon material conveyed in the conveying direction by the conveyor strikes under an acute angle the guide rail and consequently undergoes a force action orthogonally to the conveying direction, which can bring about an orientation change. Through an adjustability of the angle between guide rail and conveying direction the strength of the silicon material impact on the guide rail and therefore the effect of the turning process brought about by the guide rail can be determined. In a preferred embodiment of the invention there are several, differently oriented guide rails arranged successively on the top side to ensure a reliable orientation change for the silicon material.

According to a further development of the invention the turning device is also formed by an arrangement of at least two conveyor belts more particularly arranged in overlapping manner in the conveying direction in order to bring about an orientation change. The at least two conveyor belts can in particular be mutually spaced, so that between the conveyor belts the silicon material covers a free path section, where it is at least briefly not in contact with a substrate, for example with one of the conveyors. The silicon material is removed from the first conveyor belt and strikes the second conveyor belt, which causes the desired orientation change. Preferably the conveyor belts are vertically spaced, so that the silicon material drops from the first conveyor belt at least virtually in free fall manner onto the second conveyor belt and thereby changes its spatial orientation. The orientation change can also be assisted by different speeds of the successively arranged conveyor belts, particularly by a higher speed of the downstream conveyor belt in an advantageous embodiment of the invention the successive conveyor belts are oriented at an angle to one another, for example the conveying directions are chosen so as to differ and in particular be in opposition.

In a further development of the invention the at least one automatic conveyor, at least one turning device and at least two wetting devices are housed in an at least almost completely closed cleaning chamber, so as to prevent an escape of process medium. As a result the typically aggressive process medium can also be applied with a high pressure to the silicon material and can in particular be atomized. This permits an advantageous cleaning action without the process medium acting on the environment. In an advantageous embodiment of the invention at a cleaning chamber inlet opening and/or outlet opening through which the silicon material can be introduced into or removed from the process chamber, a sealing device is provided, particularly in the form of flexible material strips and/or in the form of an air or water curtain, so that it is possible to virtually entirely prevent an escape of atomized process medium from the cleaning chamber.

In a further development of the invention a rinsing device is integrated into the cleaning chamber. This brings about a completely integrated wet chemical cleaning of the silicon material with a process medium and a directly following rinsing process in a cleaning chamber.

In an alternative development of the invention the rinsing device is constructed as a separate rinsing module and is located behind the cleaning chamber in the conveying direction. This permits the separate processing of process medium and rinsing medium, which can be collected in the separate modules, so that in each case there can be a treatment specifically adapted to the given media. Moreover, with such an arrangement of cleaning chamber and rinsing device, the cleaning and rinsing processes taking place do not undesirably affect one another.

In a further development of the invention the rinsing device, drying device and cleaning chamber are constructed in modular manner and can be coupled to one another in a random order. As a result there can be a freely predeterminable order of cleaning processes with different process media and optionally intermediately provided rinsing and/or drying processes. This permits an advantageous adaptation to different cleaning requirements for the silicon material to be processed.

In a further development of the invention with the conveyor are associated a reception station and/or a delivery station constructed for the conveying in and/or out of the silicon material. The reception station and delivery station can be implemented as conveyor belts and permit a continuous silicon material conveying into the at least one cleaning chamber and a conveying of the process silicon material out of the cleaning chamber or the downstream rinsing device or drying device.

These and further features can be gathered from the claims, description and drawings and the individual features, both singly and in the form of subcombinations can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWING

An embodiment of the invention is described in greater detail hereinafter relative to the attached diagrammatic drawing, wherein show:

FIG. 1 A diagrammatic representation of a cleaning chamber with a downstream rinsing device and several conveyors in the form of conveyor belts.

### DETAILED DESCRIPTION OF THE EMBODIMENT

A device 1 for the processing of silicon material 3 has several successively partially vertically overlapping automatic conveyors in the form of conveyor belts 2.1 to 2.7 for conveying silicon material 3 in at least one conveying direction 4. By means of the conveyor belts 2.1 to 2.7 the silicon material 3 can be conveyed through a cleaning chamber 5 and a downstream rinsing chamber 6 and can be subject to the action of process medium 7 and rinsing medium 8.

A first conveyor belt 2.1 is constructed as a reception station and serves to convey silicon material 3 into cleaning chamber 5. The first conveyor belt 2.1 is arranged vertically above and overlapping with respect to the second conveyor belt 2.2, so that silicon material 3 can drop from the first conveyor belt 2.1 along a short free fall section onto the second conveyor belt 2.2. It is common to all the conveyor belts 2.1 to 2.7 that the silicon material 3 can be conveyed on a surface of a top side 9 of a flexible, mesh-like and therefore liquid-permeable belt 10 directed away from the conveyor belt 2.1 to 2.7. A surface normal 11 of the surface of the top side 9 is at least substantially oriented in the vertical direction 14, so that the circulating belt 10 can convey the silicon material 3 in at least preponderantly horizontal direction. To permit a compact arrangement of the conveyor belts 2.2 to 2.6 and therefore keep low the space demand for the cleaning chamber 5 and downstream rinsing chamber 6, the conveyor belts 2.2 to 2.6 are in each case oriented parallel to one another and the surface normals 11 assume an acute angle to the vertical 14, for example an angle of 5° to 30°.

With the second conveyor belt 2.2 and also the further conveyor belts 2.3 and 2.4 is in each case associated a wetting device. By means of the wetting devices constructed as spray nozzle arrangements 12 and which are arranged partly vertically above top side 9 and partly vertically below top side 9, it is possible to implement a virtually all-sided wetting of the silicon material 3 with a process medium 7. The process medium 7 is supplied to the spray nozzle arrangements 12 by means of medium lines 13, by pressurization through not shown nozzle openings is discharged as an atomized spray cone in the direction of top side 9 and therefore in the direction of silicon material 3 and sprayed onto said silicon material 3. Through the arrangement of the spray nozzles 12 in a cleaning chamber 5 it is possible to bring about a high pressure wetting of silicon material 3 with process medium 7, without this leading to atomized process medium passing in uncontrollable manner into the environment. The spray nozzle arrangements 12 are in each case associated with the conveyor belts 2.2, 2.3 and 2.4, the spray cones of the spray nozzle arrangements 12 in each case engaging the end regions of conveyor belts 2.2 and 2.3. This ensures that the silicon material 3 is still wetted with process medium 7 during the orientation changes brought about through the cascade-like arrangement of the conveyor belts.

Excess process medium 7 and process medium 7 provided with detached silicon material contaminants can drip vertically downwards and can therefore be received in a not shown collecting or treatment tank for disposal or processing of the spent process medium. The spray nozzle arrangements 12 are provided for a continuous delivery of process medium 7, so that silicon material conveyed on conveyor belts 2.2 to 2.4 is also exposed to a virtually continuous process medium wetting.

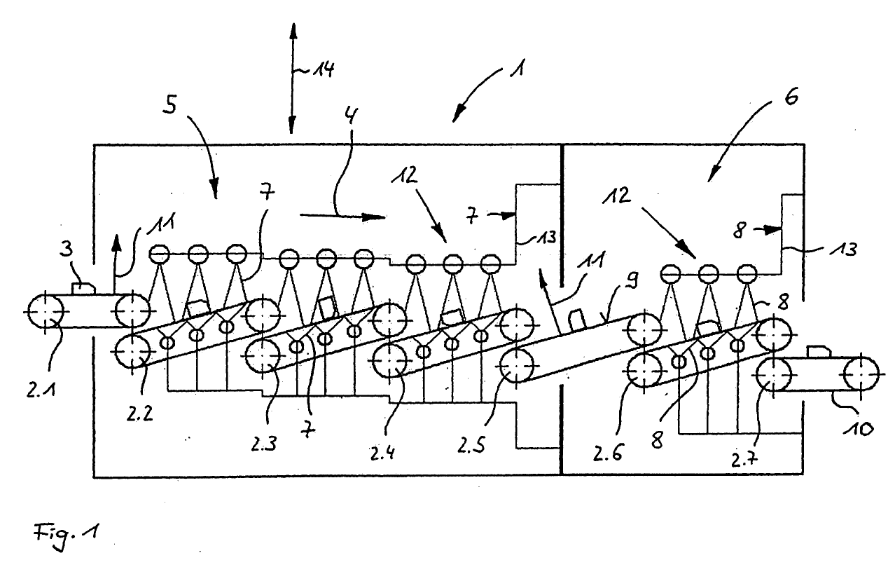

With a first spatial orientation the silicon material 3 rests on the first conveyor belt 2.1 and is conveyed in conveying direction 4 on the second conveyor belt 2.2. Through the vertically downwardly displaced, overlapping arrangement of the second conveyor belt 2.2, on reaching an end region of conveyor belt 2.1 the silicon material 3 drops vertically onto the second conveyor belt 2.2 and there is also a change to the spatial orientation of the silicon material 3, for example a rotation takes place. This also applies to the further conveyor belts 2.3 to 2.7, so that during each transition from the preceding to the following conveyor belt 2.1 to 2.7 the silicon material 3 undergoes an orientation change, as is diagrammatically indicated in FIG. 1. Thus, the overlapping conveyor belts 2.1 to 2.7 form a turning device for the silicon material 3.

Conveyor belt 2.5 is provided for a transfer of silicon material 3 from cleaning chamber 5 into rinsing chamber 6, where there is also a spray nozzle arrangement 12, which wets the silicon material virtually on all sides with rinsing medium 8, particularly with deionized water.

In a not shown embodiment of the invention a grading device is provided, which grades the treated silicon material during or after a cleaning step with respect to the size of the individual lumps. Preferably the grading device is associated with the delivery station, so that grading takes place following complete silicon material cleaning.

1. Method for processing or treating solid or bulk silicon material with a cleaning process having the following steps:
wetting said silicon material with a first liquid process medium, wherein said silicon material is oriented in a first orientation,
changing the orientation of said silicon material by means of a turning device and
wetting said silicon material in said changed orientation with said first liquid process medium.

2. Method according to claim 1, wherein said cleaning process has at least three wetting processes, wherein before a second and third of said wetting processes said orientation of said silicon material is changed.

3. Method according to claim 1, wherein said wetting of said silicon material with said first process medium also takes place during said orientation change.

4. Method according to claim 1, wherein said first cleaning process is followed by at least one similarly performed cleaning process with a different second process media, in which at least a first wetting of said silicon material with said second process medium, at least one said orientation change of said silicon material and at least one further wetting of said silicon material with said second process medium is performed.

5. Method according to claim 1, wherein said process medium is constituted by at least one of the following process media: hydrofluoric acid (HF), hydrochloric acid (HCl), nitric acid (HNO₃) and potassium hydroxide solution (KOH).

6. Method according to claim 4, wherein for said first cleaning process said process medium is constituted by water-dissolved hydrofluoric acid (HF_{(aq)}) or water-dissolved nitric acid (HNO_{3(aq)}), for said second cleaning process said process medium is water-dissolved potassium hydroxide solution (KOH_{(aq)}) and for a third cleaning process said process medium is water-dissolved hydrochloric acid (HCl_{(aq)}).

7. Method according to claim 1, wherein after every said cleaning process there is a rinsing process.

8. Method according to claim 1, wherein said cleaning process is performed with a substantially continuous, automated conveying of said silicon material with a substantially continuous wetting of said silicon material with said process medium and with at least one said orientation change for said silicon material.

9. Method according to claim 1, wherein for a change to said spatial orientation said silicon material is conveyed by a first conveyor onto a second conveyor spaced from said first conveyor, said second conveyor being positioned below said first conveyor so that said silicon material drops from said first conveyor accompanied by a change to said spatial orientation of said silicon material onto said second conveyor.

10. Method according to claim 1, wherein following at least one said cleaning process a drying process for said silicon material is performed.

11. Method according to claim 7, wherein following at least one said rinsing process a drying process for said silicon material is performed.

12. Device for processing silicon material with said method of claim 1, with at least one conveyor for conveying said silicon material in at least one conveying direction, with at least one turning device associated with said conveyor for changing a spatial orientation of said silicon material and with at least one wetting device for wetting said silicon material with a process medium placed upstream of said turning device in said conveying direction and at least one other said wetting device downstream of said turning device in said conveying direction.

13. Device according to claim 12, wherein said conveyor is elongated.

14. Device according to claim 12, wherein said conveyor comprises a circulating, continuous conveyor belt with a top side and a bottom side, said top side being oriented under an acute angle to a horizontal and which serves for conveying said silicon material.

15. Device according to claim 14, wherein said conveyor belt is made from a process medium-permeable material.

16. Device according to claim 14, wherein said turning device is constituted by at least one guide rail for an orientation change of said silicon material positioned under an acute angle to said conveying direction and which is orthogonal and adjacent to a surface of said top side.

17. Device according to claim 12, wherein said turning -device is formed by an arrangement of at least two said conveyor belts arranged in overlapping manner in said conveying direction, in order to bring about an orientation change to said silicon material.

18. Device according to claim 12, wherein at least one said conveyor with automatic function, at least one said turning device and at least two said wetting devices are housed in an at least substantially closed cleaning chamber of said device in order to prevent an escape of said process medium.

19. Device according to claim 18, wherein a rinsing device is provided and integrated into said cleaning chamber.
